(19) United States
(12) Patent Application Publication
(10) Pub. No.: US 2025/0287219 A1
(43) Pub. Date: Sep. 11, 2025

(54) BLOCKAGE PREDICTION REPORT

(71) Applicant: QUALCOMM Incorporated, San Diego, CA (US)

(72) Inventors: Hamed PEZESHKI, San Diego, CA (US); Mahmoud TAHERZADEH BOROUJENI, San Diego, CA (US); Qiaoyu LI, Beijing (CN); Tao LUO, San Diego, CA (US)

(21) Appl. No.: 18/861,265

(22) PCT Filed: Jun. 30, 2022
(86) PCT No.: PCT/CN2022/102777

§ 371 Date: Oct. 29, 2024

(51) Int. Cl. H04W 16/18; H04B 7/06; H04W 24/10

(52) U.S. Cl. CPC H04W 16/18; H04B 7/0617; H04W 24/10

(57) ABSTRACT

Various aspects of the present disclosure generally relate to wireless communication. In some aspects, a user equipment (UE) may obtain measurement information regarding a set of reference signals. The UE may generate, using a model, predicted blockage information based at least in part on the measurement information. The UE may transmit a report indicating the predicted blockage information, wherein the report indicates at least one of: a prediction window associated with the predicted blockage information, a time associated with an occurrence of a predicted blockage event, a severity value associated with the predicted blockage event, or a direction value associated with the predicted blockage event. Numerous other aspects are described.

### FIELD OF THE DISCLOSURE

Aspects of the present disclosure generally relate to wireless communication and to techniques and apparatuses for a blockage prediction report.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining measurement information regarding a set of reference signals. The method may include generating, using a model, predicted blockage information based at least in part on the measurement information. The method may include transmitting a report indicating the predicted blockage information, wherein the report indicates at least one of a prediction window associated with the predicted blockage information, a time associated with an occurrence of a predicted blockage event, a severity value associated with the predicted blockage event, or a direction value associated with the predicted blockage event.

Some aspects described herein relate to a UE for wireless communication. The UE may include a memory and one or more processors coupled to the memory. The one or more processors may be configured to obtain measurement information regarding a set of reference signals. The one or more processors may be configured to generate, using a model, predicted blockage information based at least in part on the measurement information. The one or more processors may be configured to transmit a report indicating the predicted blockage information, wherein the report indicates at least one of a prediction window associated with the predicted blockage information, a time associated with an occurrence of a predicted blockage event, a severity value associated with the predicted blockage event, or a direction value associated with the predicted blockage event.

Some aspects described herein relate to a non-transitory computer-readable medium that stores a set of instructions for wireless communication by a UE. The set of instructions, when executed by one or more processors of the UE, may cause the UE to obtain measurement information regarding a set of reference signals. The set of instructions, when executed by one or more processors of the UE, may cause the UE to generate, using a model, predicted blockage information based at least in part on the measurement information. The set of instructions, when executed by one or more processors of the UE, may cause the UE to transmit a report indicating the predicted blockage information, wherein the report indicates at least one of a prediction window associated with the predicted blockage information, a time associated with an occurrence of a predicted blockage event, a severity value associated with the predicted blockage event, or a direction value associated with the predicted blockage event.

Some aspects described herein relate to an apparatus for wireless communication. The apparatus may include means for obtaining measurement information regarding a set of reference signals. The apparatus may include means for generating, using a model, predicted blockage information based at least in part on the measurement information. The apparatus may include means for transmitting a report indicating the predicted blockage information, wherein the report indicates at least one of a prediction window associated with the predicted blockage information, a time associated with an occurrence of a predicted blockage event, a severity value associated with the predicted blockage event, or a direction value associated with the predicted blockage event.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end- user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example 400 of signaling associated with blockage prediction using wireless sensing.

FIG. 5 is a diagram illustrating an example 500 of training and using a model in connection with predicting blockages, in accordance with the present disclosure.

FIG. 6 is a diagram illustrating an example process 600 performed, for example, by a UE, in accordance with the present disclosure.

FIG. 7 is a diagram of an example apparatus 700 for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

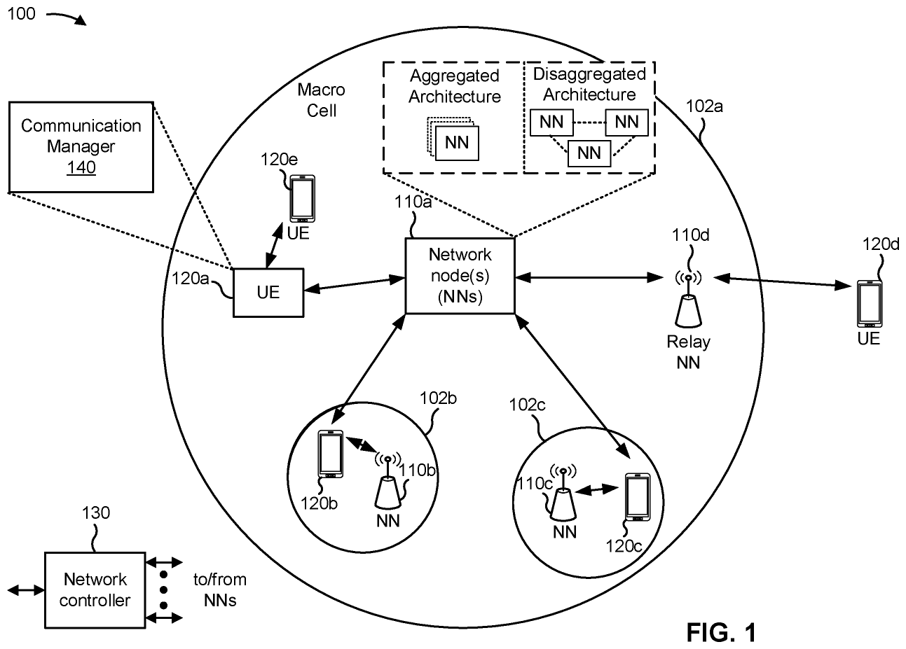

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain measurement information regarding a set of reference signals; generate, using a model, predicted blockage information based at least in part on the measurement information; and transmit a report indicating the predicted blockage information, wherein the report indicates at least one of: a prediction window associated with the predicted blockage information, a time associated with an occurrence of a predicted blockage event, a severity value associated with the predicted blockage event, or a direction value associated with the predicted blockage event. Additionally, or alternatively, the communication manager 140 may perform one or more other operations described herein.

As indicated above, FIG. 1 is provided as an example. Other examples may differ from what is described with regard to FIG. 1.

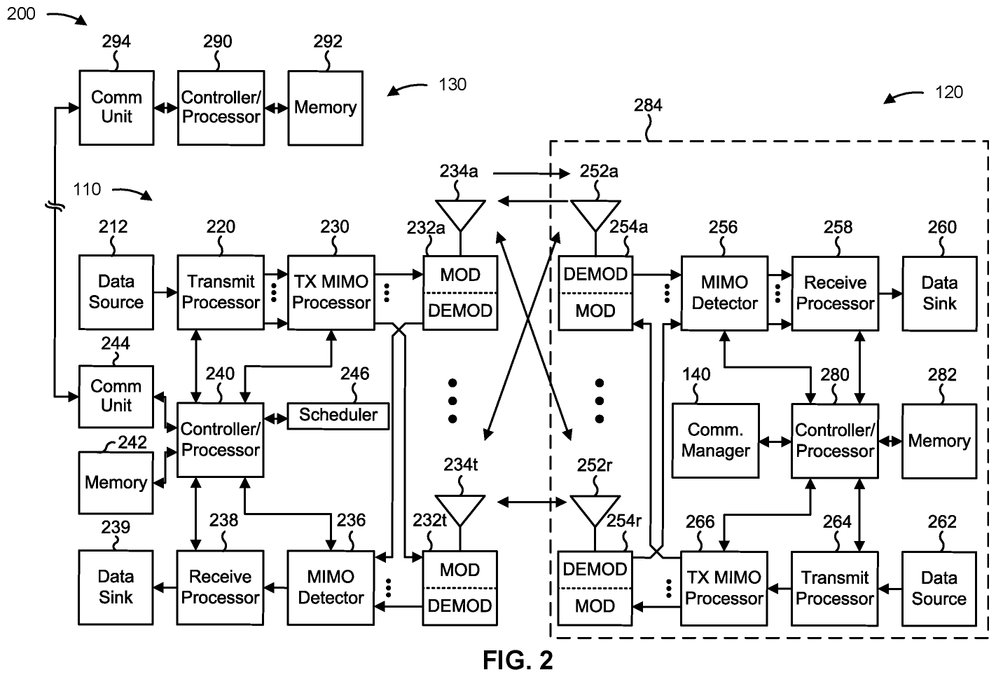

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

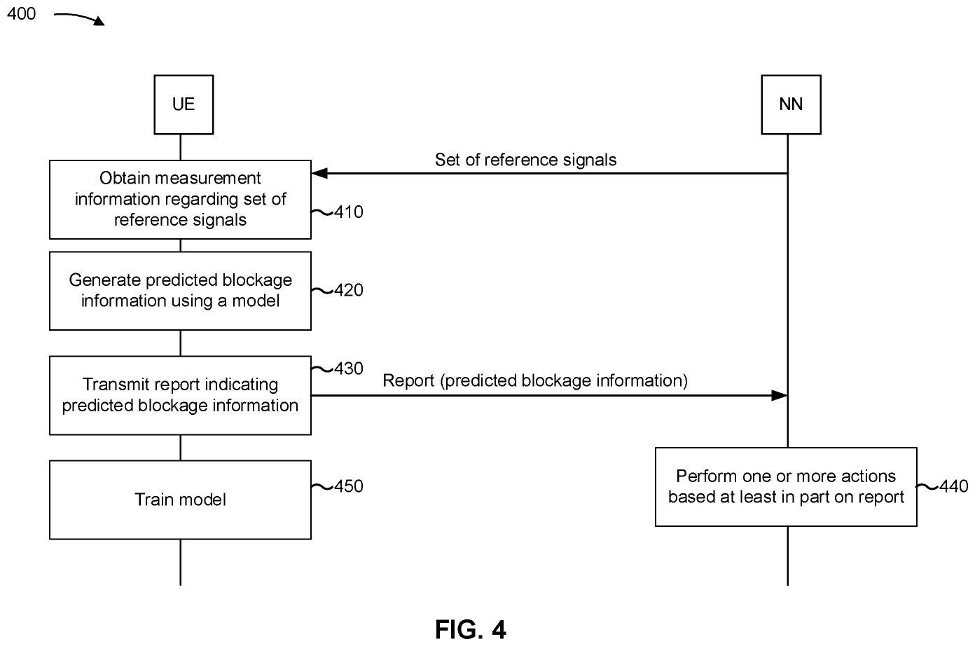

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

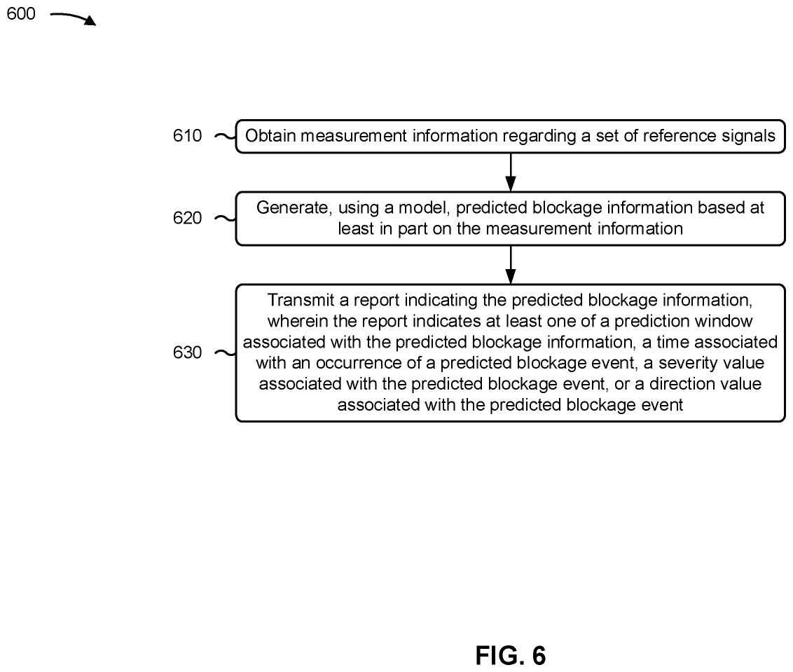

The controller/processor 240 of the network node 110, the controller/processor 280 of the UE 120, and/or any other component(s) of FIG. 2 may perform one or more techniques associated with blockage prediction reporting, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for obtaining measurement information regarding a set of reference signals; means for generating, using a model, predicted blockage information based at least in part on the measurement information; and/or means for transmitting a report indicating the predicted blockage information, wherein the report indicates at least one of: a prediction window associated with the predicted blockage information, a time associated with an occurrence of a predicted blockage event, a severity value associated with the predicted blockage event, or a direction value associated with the predicted blockage event. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

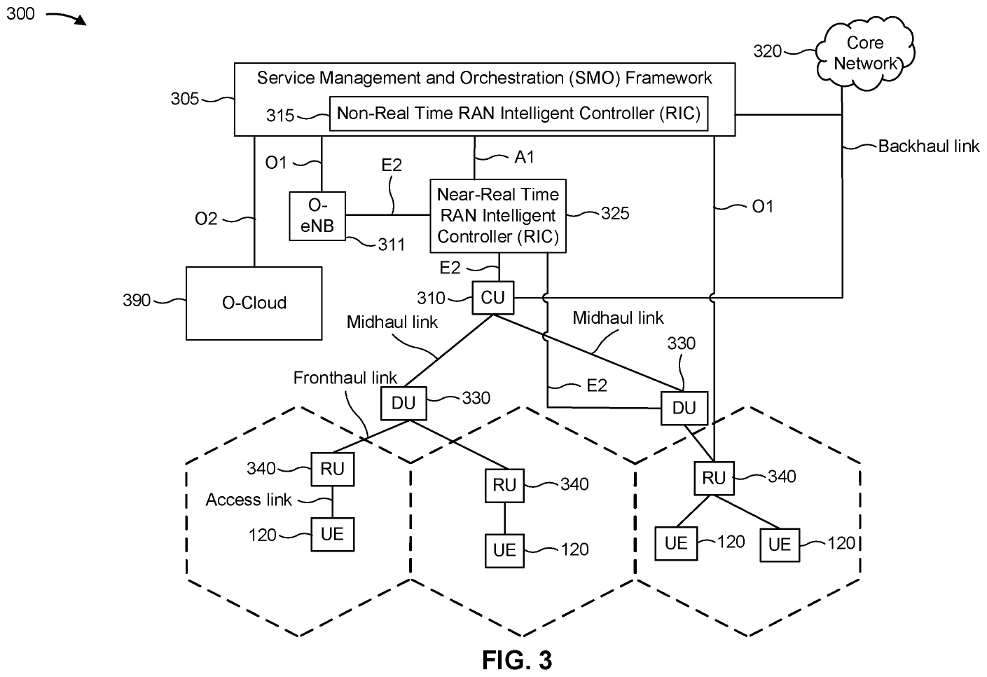

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Wireless communication devices (such as UEs 120 and network nodes 110) may communicate using beamforming. Beamforming involves the generation of a beam by manipulating the electrical properties (e.g., phase, amplitude) of antennas relative to one another. Beamforming is useful for higher-frequency communications, such as in FR2 or FR4, because such communications experience increased attenuation and are more susceptible to blockage relative to lower-frequency communications, such as those in FR1.

A blockage is a channel condition in which a communication transmitted by a transmitter is blocked from reaching a receiver to which the communication is directed (such as using a beam). For example, a blockage can be caused by an object moving into the propagation path between the transmitter and the receiver. A blockage can lead to a partial or total failure to receive the communication. Therefore, it may be beneficial to predict blockages before or as they occur so that a transmitter and/or a receiver can take mitigating action (such as selecting an unblocked beam or scheduling around the blockage so that the pertinent communication is still received by the receiver). However, procedures for creating (e.g., training) a model to predict blockages are not well-defined. Furthermore, a reporting format (e.g., the contents of a report) for reporting of predicted blockage events is not well defined. Without well-structured procedures for creating a model and reporting predicted blockage events based at least in part on the model, ambiguity may arise in the training of the model and/or the reporting of predicted blockage events, which may increase interruption of communications due to blockages and reduce the efficacy of blockage prediction and reporting.

Some techniques described herein provide reporting of blockages identified using a model. For example, the UE may transmit a report indicating whether or not a blockage is predicted, a probability associated with a predicted blockage event, a time associated with a predicted blockage event, a severity associated with a predicted blockage event, a direction associated with a predicted blockage event, or the like. In some aspects, the UE may transmit the report prior to the blockage occurring, such that the report indicates a predicted blockage event. Thus, the network node can perform a mitigating action, such as proactively switching a downlink beam to avoid beam failure due to the predicted blockage event. Some techniques described herein provide training of a model (such as a neural network) to identify predicted blockage events. For example, some techniques described herein identify techniques for labeling variables associated with training a model and/or unsupervised learning configurations for training the model such that accuracy of predicting blockages is improved. In this way, the UE can train and update a model for predicting blockages, which improves performance of the model in view of conditions at the UE as compared to a “one size fits all” model that is deployed at many different UEs.

FIG. 4 is a diagram illustrating an example 400 of signaling associated with blockage prediction using wireless sensing. As shown, example 400 includes a UE (e.g., UE 120) and a network node (e.g., network node (NN) 110). In some aspects, the UE and the network node may have a communication link. For example, the UE and the network node may communicate via a communication link using beams. Techniques described herein provide prediction of blockage of the communication link and reporting associated with the prediction.

In some aspects, the UE may receive configuration information from the network node. For example, the configuration information may include a configuration for blockage prediction using wireless sensing. In some aspects, the configuration may indicate content to include in a report indicating predicted blockage information. For example, the configuration may indicate one or more values to be included in the predicted blockage information. In some aspects, the configuration may indicate one or more parameters associated with a model for blockage prediction, such as one or more parameters for training the model, one or more outputs to be generated by the model, or the like. In some aspects, the configuration information may be based at least in part on capability information transmitted by the UE, which may indicate a capability for blockage prediction, one or more requested parameters for the model, or the like.

As shown by reference number 410, the UE may obtain measurement information regarding a set of reference signals. The network node (e.g., a radio unit associated with the network node) may transmit the set of reference signals. In some aspects, the UE may obtain the measurement information by performing one or more measurements, such as by performing wireless sensing. For example, the UE may perform measurements on multiple different beams at different times (e.g., a first measurement on a first beam, then a second measurement on a second beam, and so on) in an observation window, which may be referred to as beamsweeping. In some aspects, the network node may transmit the set of reference signals using beamsweeping. For example, the network node may transmit reference signals on multiple different beams at different times (e.g., a first reference signal at a first time, a second reference signal at a second time, and so on). In some aspects, both the UE and the network node may perform beamsweeping. In some aspects, the measurement information may indicate measurement values associated with the set of reference signals. For example, the measurement values may include RSRP values. In some aspects, the measurement values may include measurement values across multiple beams over a time duration. The time duration to which the measurement information relates may be referred to herein as an observation window. In some aspects, the measurement information may include information regarding the set of reference signals across a range of beam directions and across the observation window. For example, the measurement information may include information regarding a plurality of beams (e.g., associated with a plurality of beam indexes) that are distributed spatially. In some aspects, the UE may obtain the measurement information (and/or the network node may transmit the set of reference signals) according to a periodicity. For example, the periodicity may be indicated in the configuration information. In some aspects, the measurement information may be in-band. For example, the measurement information may relate to measurements performed in a same frequency range or channel bandwidth as communications between the UE and the network node. In some aspects, the measurements may be mm Wave measurements. The measurement information may be used to predict blockages in a prediction window, as described below. A prediction window is a time window for which the UE (e.g., a model) predicts predicted blockage events.

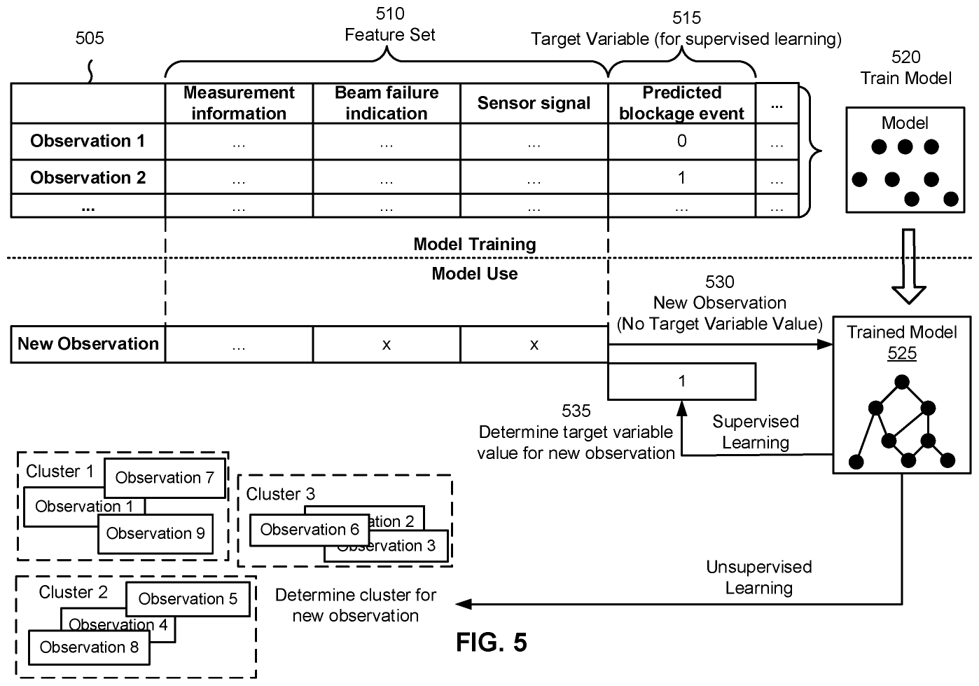

As shown by reference number 420, the UE may generate predicted blockage information using a model. In some aspects, the model may include a neural network, such as a convolutional neural network (CNN) or a recurrent neural network. The model may be trained using a machine learning algorithm, as described in more detail in connection with FIG. 5. The model may receive, as input, the measurement information, information derived from the measurement information, or a part of the measurement information. The model may output predicted blockage information. Reporting the predicted blockage information is shown in association with reference number 430, and is described in more detail below.

The predicted blockage information may be associated with a prediction window. The prediction window is a time window for which the UE predicts predicted blockage events. For example, the predicted blockage information may indicate one or more predicted blockage events that are predicted to occur in the time window and/or information associated with the one or more predicted blockage events, as described below.

In some aspects, the predicted blockage information may indicate a predicted blockage event. For example, the predicted blockage information may indicate whether or not a blockage is predicted to occur in the prediction window, which may be referred to as a binary output. As another example, the predicted blockage information may indicate a probability associated with the predicted blockage event. For example, the predicted blockage information may be associated with a granularity. The predicted blockage information may indicate the probability in accordance with the granularity. For example, at a granularity of 2, a first value may indicate a 0%-50% probability of a blockage, and a second value may indicate a 50-100% probability of a blockage. In some aspects, the granularity may be configurable. In some aspects, the granularity may be selected from multiple granularities, which provides flexibility between precision of the predicted blockage information and overhead reduction. In some aspects, the UE may select the granularity, for example, based at least in part on a level of confidence regarding occurrence of the predicted blockage event.

In some aspects, the predicted blockage information may indicate a time associated with an occurrence of a predicted blockage event. For example, the time may occur within the prediction window. In some aspects, the predicted blockage information indicates the time based at least in part on at least one of a time value or a time range. For example, the predicted blockage information may indicate a time window that identifies a predicted start of the predicted blockage event, a predicted end of the blockage, a predicted center time of the predicted blockage event, or a combination thereof, where the time window represents the occurrence of the predicted blockage event. As another example, the predicted blockage information may indicate a time range (which may indicate a confidence level) for the predicted blockage event, such as a standard deviation (in terms of time) associated with the time value, where the time range represents the occurrence of the predicted blockage event. For example, the predicted blockage information may identify a predicted blockage event with an occurrence at a time 20 ms from the start of the prediction window plus or minus 5 ms. In this way, the UE may provide the network node with visibility regarding when the predicted blockage event is predicted to happen and how fast the proactive beam change should be triggered.

Additionally, or alternatively, the predicted blockage information may indicate a selected time interval, of the prediction window, indicating the time. For example, the prediction window may be divided into a number of time intervals. The predicted blockage information may include an index corresponding to a time interval in which an occurrence of the predicted blockage event is predicted. As one example, the prediction window may be divided into 8 time intervals, and 3 bits can be used to indicate a time interval including the occurrence of the predicted blockage event, which may reduce overhead relative to explicit signaling of the time value and/or the time range.

In some aspects, the predicted blockage information may indicate a severity value associated with the predicted blockage event. In some aspects, the severity value may indicate an expected duration of the predicted blockage event. For example, a longer predicted blockage event may be considered more severe than a shorter predicted blockage event. In some aspects, the severity value may include a quantized value. For example, a first value may indicate a first range of expected duration (e.g., 0 ms to 200 ms), a second value may indicate a second range of expected duration (e.g., 200 ms to 500 ms), and so on. In some aspects, the severity value may be based at least in part on a signature of the measurement information. For example, different blockers (e.g., different obstructions causing predicted blockage events, such as a bicycle, a motorcycle, a truck, a bus, and so on) may be associated with different signatures in the measurement information. The model may output an indication of a severity value. The indication may be based at least in part on a signature in the measurement information.

In some aspects, the severity value may indicate a degree of blockage. For example, a predicted blockage event may lead to degradation of the communication link between the UE and the network node, without fully blocking the communication link. In this example, the predicted blockage information may indicate a predicted degree of blockage associated with the predicted blockage.

In some aspects, the predicted blockage information may indicate a direction value associated with the predicted blockage event. The direction value may indicate a direction associated with a blocker causing the predicted blockage event. In some aspects, a direction value may be binary. For example, a predicted blockage event originating from a first direction of two directions (such as a first direction on a two-way street) may be associated with a first direction value, and a predicted blockage event originating from a second direction of the two directions may be associated with a second direction value. In some aspects, the direction value may be expressed relative to a reference point (which may be a direction associated with a beam, a geographical location, a set of coordinates, or the like). For example, the reference point may be known to the UE and the network node. A first direction value (where the direction value may or may not be binary) may indicate that the predicted blockage event originates from a first direction relative to the reference point, and a second direction value may indicate that the predicted blockage event originates from a second direction relative to the reference point. Providing a prediction of the direction value can help in terms of candidate beam identification for beam failure recovery procedure. For example, if the UE predicts that the direction of the moving blocker is from left to right, the network node can indicate the candidate beams that are in the opposite direction of the moving blocker, which have a lower probability of being blocked.

In some aspects, the direction value indicates one or more parameters relating to movement associated with a moving blocker. For example, the blocker associated with (e.g., causing) a predicted blockage event may be in motion relative to the UE and/or a network node associated with (e.g., communicating with, serving) the UE. The one or more parameters may indicate a direction (e.g., a vector, an indication of left or right, an indication of a hemisphere, or the like) associated with the blocker, a rate of movement (e.g., a linear speed, a linear velocity, an angular speed, an angular velocity, or the like) associated with the blocker, a direction of movement (e.g., a vector, a cardinal direction, or the like) associated with the blocker, or the like. In some aspects, the one or more parameters may be expressed relative to a reference point, as described above. In some aspects, the one or more parameters may relate to movement of a blockage associated with the predicted blockage event. For example, the one or more parameters may indicate a direction, a rate of movement, and/or a direction of movement associated with a blockage (which may be represented as a blocked area on a sphere surrounding the UE). In some aspects, the direction value may be based at least in part on at least one of movement of the UE or movement of a network node associated with the UE. For example, the UE may take into account a direction, a rate of movement, an orientation, and/or a direction of movement of the UE and/or a network node associated with (e.g., serving, communicating with) the UE when determining the direction value associated with the predicted blockage event.

As shown by reference number 430, the UE may transmit a report indicating the predicted blockage information. For example, the UE may transmit the report via uplink control information (UCI), a medium access control (MAC) control element, or the like. In some aspects, the UE may transmit the report periodically (e.g., every X ms, where X is a number). In some aspects, the UE may transmit the report based at least in part on identifying a predicted blockage event. For example, the UE may transmit the report in response to identifying a predicted blockage event, and the predicted blockage information may indicate the predicted blockage event. In some aspects, the report may include information indicating a duration of the prediction window, which enables the network node to proactively switch a downlink beam of the UE to avoid beam failure.

In some aspects, the report may indicate the time associated with the predicted blockage event. For example, the report may indicate the time value, the time range, and/or the selected interval associated with the predicted blockage event, as described in connection with reference number 420. In some aspects, the report may indicate the severity value associated with the predicted blockage event. For example, the report may indicate the expected duration, a quantized version of the expected duration, or the like, as described in connection with reference number 420. In some aspects, the report may indicate the direction value associated with the predicted blockage event. For example, the report may indicate a binary or non-binary direction value, which may be defined relative to a reference point, as described with regard to reference number 420.

As shown by reference number 440, the network node may perform one or more actions based at least in part on the report. For example, the network node may switch the UE to a beam that is not associated with the predicted blockage event. As another example, the network node may identify a set of UEs that are associated with the predicted blockage event based at least in part on the predicted blockage information, and may switch beams associated with the set of UEs such that communications with the set of UEs are not interrupted.

As shown by reference number 450, the UE may train the model. For example, the UE may train the model using a machine learning algorithm (e.g., a machine learning module). The training of the module using a machine learning algorithm is described in more detail in connection with FIG. 5.

In some aspects, the UE may train the model based at least in part on information gathered by the UE. For example, the UE may train the model based at least in part on a beam failure indication associated with a beam failure detection (BFD) procedure. If a predicted blockage event is associated with a beam failure indication, then the UE may assign a first label (e.g., 1) to the predicted blockage event. If the predicted blockage event is not associated with a beam failure indication (that is, if no blockage actually occurs), then the UE may assign a second label (e.g., 0) to the predicted blockage event. As another example, if a time of an occurrence of a predicted blockage event is within a threshold length of time from a time associated with a beam failure indication in the prediction window, the UE may assign a first label, and may assign a second label if the time of the predicted blockage event is not within a threshold time of the time associated with the beam failure indication. In some aspects, the time associated with the beam failure indication may be measured from the end of the observation window to a time at which the beam failure indication (or an observed blockage associated with the beam failure indication) occurs. As yet another example, if a duration of the predicted blockage event is within a threshold length of a duration associated with a beam failure indication associated with a serving beam (such as a duration between a time at which BFD occurs and a time at which a connection is restored using a beam associated with the BFD), the UE may assign a first label to a severity value, and may assign a second label if the duration of the predicted blockage event is not within the threshold length of the duration associated with the beam failure indication. In some aspects, the serving beam may be a line of sight (LOS) beam.

In some aspects, the UE may train the model based at least in part on a signal from a sensor. For example, the signal from the sensor may provide information that can be used to determine whether a blockage is observed and/or to determine information associated with predicting a blockage. In some examples, the sensor is a blockage sensor. In some aspects, the sensor may comprise or be associated with a camera. For example, the UE may determine, based at least in part on multiple images or a video gathered by the camera, a direction associated with a blockage (e.g., the images or video may indicate whether a source of the blockage is moving in a first direction or moving in a second direction). The UE may assign a label to a direction value of predicted blockage information based at least in part on the signal from the sensor.

In some aspects, the UE may train the model based at least in part on an indication of a relative direction of a downlink beam. For example, the UE may receive, from the network node, an indication of a relative direction of a downlink beam. For example, the relative direction may be based at least in part on a downlink beam direction in terms of azimuth and/or elevation (e.g., the “relative direction” in azimuth can be represented as left (beam pointing to the left of the gNB panel), center, or right). The UE may train the model based at least in part on the indication of the relative direction. For example, the UE may perform a non-supervised learning technique utilizing the indication of the relative direction of the downlink beam, such as to train the model to identify the direction value.

As indicated above, FIG. 4 is provided as an example. Other examples may differ from what is described with regard to FIG. 4.

FIG. 5 is a diagram illustrating an example 500 of training and using a model in connection with predicting blockages, in accordance with the present disclosure. The model training and usage described herein may be performed using a machine learning system. The machine learning system may include or may be included in a computing device, a server, a cloud computing environment, or the like, such as the UE 120 described in more detail elsewhere herein.

As shown by reference number 505, a model may be trained using a set of observations. The set of observations may be obtained from training data (e.g., historical data), such as data gathered during one or more processes described herein.

As shown by reference number 510, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the network node. For example, the machine learning system may identify a feature set (e.g., one or more features and/or feature values) by extracting the feature set from structured data, and/or by receiving input from an operator.

As an example, a feature set for a set of observations may include a first feature of measurement information, a second feature of a beam failure indication, a third feature of a sensor signal, a fourth feature of an indication of a relative direction associated with a beam, and so on. These features values are provided as examples, and may differ in other examples. For example, the feature set may include an observed time associated with a blockage, an observed severity value associated with a blockage, a blockage, or the like. In some examples, one or more features of the feature set may be used for training of the model and not for usage of the model. In some other examples, each feature of the feature set may be used for training and usage of the model. In some examples, the beam failure indication and/or the sensor signal

As shown by reference number 515, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels) and/or may represent a variable having a Boolean value. A target variable may be associated with a target variable value, and a target variable value may be specific to an observation.

The target variable may represent a value that a model is being trained to predict, and the feature set may represent the variables that are input to a trained model to predict a value for the target variable. The set of observations may include target variable values so that the model can be trained to recognize patterns in the feature set that lead to a target variable value. A model that is trained to predict a target variable value may be referred to as a supervised learning model.

In some implementations, the model may be trained on a set of observations that do not include a target variable. This may be referred to as an unsupervised learning model. In this case, the model may learn patterns from the set of observations without labeling or supervision, and may provide output that indicates such patterns, such as by using clustering and/or association to identify related groups of items within the set of observations.

As shown by reference number 520, the machine learning system may train a model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the model as a trained model 525 to be used to analyze new observations.

As shown by reference number 530, the machine learning system may apply the trained model 525 to a new observation, such as by receiving a new observation and inputting the new observation to the trained model 525. As shown, the new observation may include a first feature of measurement information, as an example. The machine learning system may apply the trained model 525 to the new observation to generate an output (e.g., a result). The type of output may depend on the type of model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained model 525 may predict a blockage based at least in part on the measurement information for the new observation, as shown by reference number 535. Based on this prediction, the machine learning system may transmit a report indicating the predicted blockage event and/or predicted blockage information associated with the predicted blockage event.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In some implementations, the trained model 525 may be re-trained using feedback information, as described in connection with reference number 450 of FIG. 4. For example, feedback may be provided to the model. The feedback may be associated with actions performed based on the recommendations provided by the trained model 525 and/or automated actions performed, or caused, by the trained model 525. In other words, the recommendations and/or actions output by the trained model 525 may be used as inputs to re-train the model (e.g., a feedback loop may be used to train and/or update the model). For example, the feedback information may include information regarding predicted blockage events, as described in connection with reference numbers 420 and 450.

As indicated above, FIG. 5 is provided as an example. Other examples may differ from what is described in connection with FIG. 5.

FIG. 6 is a diagram illustrating an example process 600 performed, for example, by a UE, in accordance with the present disclosure. Example process 600 is an example where the UE (e.g., UE 120) performs operations associated with blockage prediction reporting.

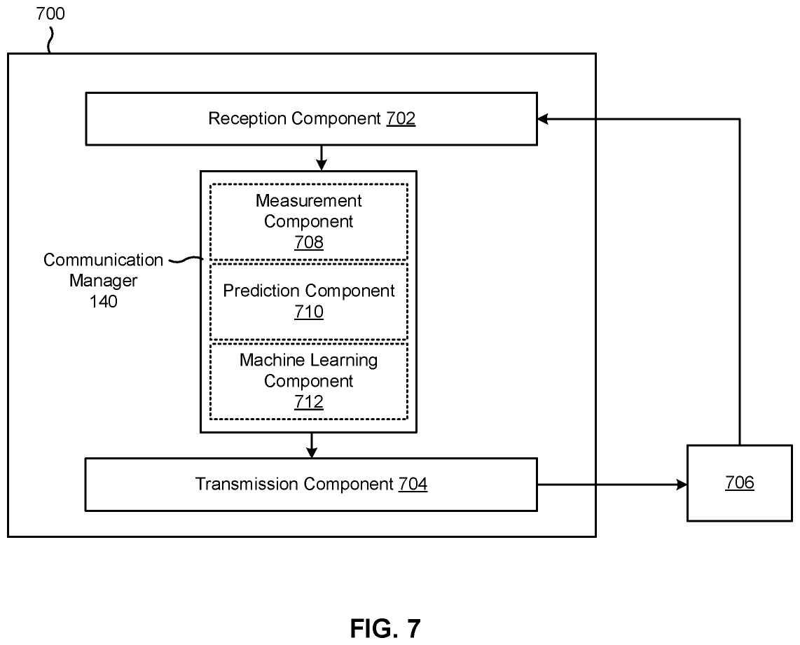

As shown in FIG. 6, in some aspects, process 600 may include obtaining measurement information regarding a set of reference signals (block 610). For example, the UE (e.g., using communication manager 140 and/or measurement component 708, depicted in FIG. 7) may obtain measurement information regarding a set of reference signals, as described above.

As further shown in FIG. 6, in some aspects, process 600 may include generating, using a model, predicted blockage information based at least in part on the measurement information (block 620). For example, the UE (e.g., using communication manager 140 and/or prediction component 710, depicted in FIG. 7) may generate, using a model, predicted blockage information based at least in part on the measurement information, as described above.

As further shown in FIG. 6, in some aspects, process 600 may include transmitting a report indicating the predicted blockage information, wherein the report indicates at least one of: a prediction window associated with the predicted blockage information, a time associated with an occurrence of a predicted blockage event, a severity value associated with the predicted blockage event, or a direction value associated with the predicted blockage event (block 630). For example, the UE (e.g., using communication manager 140 and/or transmission component 704, depicted in FIG. 7) may transmit a report indicating the predicted blockage information, wherein the report indicates at least one of: a prediction window associated with the predicted blockage information, a time associated with an occurrence of a predicted blockage event, a severity value associated with the predicted blockage event, or a direction value associated with the predicted blockage event, as described above.

Process 600 may include additional aspects, such as any single aspect or any combination of aspects described below and/or in connection with one or more other processes described elsewhere herein.

In a first aspect, the predicted blockage information indicates the time based at least in part on at least one of a time value or a time range.

In a second aspect, alone or in combination with the first aspect, the predicted blockage information indicates a selected time interval, of the prediction window, indicating the time.

In a third aspect, alone or in combination with one or more of the first and second aspects, the severity value is associated with an expected duration of the predicted blockage event.

In a fourth aspect, alone or in combination with one or more of the first through third aspects, the direction value is a binary value.

In a fifth aspect, alone or in combination with one or more of the first through fourth aspects, the direction value is expressed relative to a reference point.

In a sixth aspect, alone or in combination with one or more of the first through fifth aspects, the model is trained based at least in part on a machine learning algorithm.

In a seventh aspect, alone or in combination with one or more of the first through sixth aspects, the model is trained based at least in part on a label assigned to a blockage.

In an eighth aspect, alone or in combination with one or more of the first through seventh aspects, the model is trained based at least in part on a label assigned to an observed time associated with a blockage.

In a ninth aspect, alone or in combination with one or more of the first through eighth aspects, the model is trained based at least in part on a label assigned to an observed severity value associated with a blockage.

In a tenth aspect, alone or in combination with one or more of the first through ninth aspects, the model is trained based at least in part on a signal from a sensor regarding an observed direction value associated with a blockage.

In an eleventh aspect, alone or in combination with one or more of the first through tenth aspects, the model is trained based at least in part on information regarding a downlink beam direction associated with an observed direction value associated with a blockage.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a measurement component 708, a prediction component 710, or a machine learning component 712, among other examples.

In some aspects, the apparatus 700 may be configured to perform one or more operations described herein in connection with FIGS. 4-5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The measurement component 708 may obtain measurement information regarding a set of reference signals. The prediction component 710 may generate, using a model, predicted blockage information based at least in part on the measurement information. The transmission component 704 may transmit a report indicating the predicted blockage information, wherein the report indicates at least one of a prediction window associated with the predicted blockage information, a time associated with an occurrence of a predicted blockage event, a severity value associated with the predicted blockage event, or a direction value associated with the predicted blockage event. The machine learning component 712 may train the model using a machine learning algorithm.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: obtaining measurement information regarding a set of reference signals; generating, using a model, predicted blockage information based at least in part on the measurement information; and transmitting a report indicating the predicted blockage information, wherein the report indicates at least one of: a prediction window associated with the predicted blockage information, a time associated with an occurrence of a predicted blockage event, a severity value associated with the predicted blockage event, or a direction value associated with the predicted blockage event.
Aspect 2: The method of Aspect 1, wherein the predicted blockage information indicates the time based at least in part on at least one of a time value or a time range.
Aspect 3: The method of any of Aspects 1-2, wherein the predicted blockage information indicates a selected time interval, of the prediction window, indicating the time.
Aspect 4: The method of any of Aspects 1-3, wherein the severity value is associated with an expected duration of the predicted blockage event.
Aspect 5: The method of any of Aspects 1-4, wherein the direction value is a binary value.
Aspect 6: The method of any of Aspects 1-5, wherein the direction value is expressed relative to a reference point.
Aspect 7: The method of any of Aspects 1-6, wherein the model is trained based at least in part on a machine learning algorithm.
Aspect 8: The method of any of Aspects 1-7, wherein the model is trained based at least in part on a label assigned to a blockage.
Aspect 9: The method of any of Aspects 1-8, wherein the model is trained based at least in part on a label assigned to an observed time associated with a blockage.
Aspect 10: The method of any of Aspects 1-9, wherein the model is trained based at least in part on a label assigned to an observed severity value associated with a blockage.
Aspect 11: The method of any of Aspects 1-10, wherein the model is trained based at least in part on a signal from a sensor regarding an observed direction value associated with a blockage.
Aspect 12: The method of any of Aspects 1-11, wherein the model is trained based at least in part on information regarding a downlink beam direction associated with an observed direction value associated with a blockage.
Aspect 13: The method of any of Aspects 1-12, wherein the direction value indicates one or more parameters relating to movement associated with a moving blocker or movement of a blockage associated with the predicted blockage event.
Aspect 14: The method of any of Aspects 1-13, wherein the direction value is based at least in part on at least one of movement of the UE or movement of a network node associated with the UE.
Aspect 15: An apparatus for wireless communication at a device, comprising a processor; memory coupled with the processor; and instructions stored in the memory and executable by the processor to cause the apparatus to perform the method of one or more of Aspects 1-14.
Aspect 16: A device for wireless communication, comprising a memory and one or more processors coupled to the memory, the one or more processors configured to perform the method of one or more of Aspects 1-14.
Aspect 17: An apparatus for wireless communication, comprising at least one means for performing the method of one or more of Aspects 1-14.
Aspect 18: A non-transitory computer-readable medium storing code for wireless communication, the code comprising instructions executable by a processor to perform the method of one or more of Aspects 1-14.
Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
obtaining measurement information regarding a set of reference signals;
generating, using a model, predicted blockage information based at least in part on the measurement information; and
transmitting a report indicating the predicted blockage information, wherein the report indicates at least one of:
a prediction window associated with the predicted blockage information,
a time associated with an occurrence of a predicted blockage event,
a severity value associated with the predicted blockage event, or
a direction value associated with the predicted blockage event.

2. The method of claim 1, wherein the predicted blockage information indicates the time based at least in part on at least one of a time value or a time range.

3. The method of claim 1, wherein the predicted blockage information indicates a selected time interval, of the prediction window, indicating the time.

4. The method of claim 1, wherein the severity value is associated with an expected duration of the predicted blockage event.

5. The method of claim 1, wherein the direction value is a binary value.

6. The method of claim 1, wherein the direction value is expressed relative to a reference point.

7. The method of claim 1, wherein the direction value indicates one or more parameters relating to movement associated with a moving blocker or movement of a blockage associated with the predicted blockage event.

8. The method of claim 1, wherein the direction value is based at least in part on at least one of movement of the UE or movement of a network node associated with the UE.

9. The method of claim 1, wherein the model is trained based at least in part on a machine learning algorithm.

10. The method of claim 1, wherein the model is trained based at least in part on a label assigned to a blockage.

11. The method of claim 1, wherein the model is trained based at least in part on a label assigned to an observed time associated with a blockage.

12. The method of claim 1, wherein the model is trained based at least in part on a label assigned to an observed severity value associated with a blockage.

13. The method of claim 1, wherein the model is trained based at least in part on a signal from a sensor regarding an observed direction value associated with a blockage.

14. The method of claim 1, wherein the model is trained based at least in part on information regarding a downlink beam direction associated with an observed direction value associated with a blockage.

15. A user equipment (UE) for wireless communication, comprising:
a memory; and
one or more processors, coupled to the memory, configured to:
obtain measurement information regarding a set of reference signals;
generate, using a model, predicted blockage information based at least in part on the measurement information; and
transmit a report indicating the predicted blockage information, wherein the report indicates at least one of:
a prediction window associated with the predicted blockage information,
a time associated with an occurrence of a predicted blockage event,
a severity value associated with the predicted blockage event, or
a direction value associated with the predicted blockage event.

16. The UE of claim 15, wherein the predicted blockage information indicates the time based at least in part on at least one of a time value or a time range.

17. The UE of claim 15, wherein the predicted blockage information indicates a selected time interval, of the prediction window, indicating the time.

18. The UE of claim 15, wherein the severity value is associated with an expected duration of the predicted blockage event.

19. The UE of claim 15, wherein the direction value is a binary value.

20. The UE of claim 15, wherein the direction value is expressed relative to a reference point.

21. The UE of claim 15, wherein the model is trained based at least in part on a machine learning algorithm.

22. The UE of claim 15, wherein the model is trained based at least in part on a label assigned to a blockage.

23. The UE of claim 15, wherein the model is trained based at least in part on a label assigned to an observed time associated with a blockage.

24. The UE of claim 15, wherein the model is trained based at least in part on a label assigned to an observed severity value associated with a blockage.

25. The UE of claim 15, wherein the model is trained based at least in part on a signal from a sensor regarding an observed direction value associated with a blockage.

26. The UE of claim 15, wherein the model is trained based at least in part on information regarding a downlink beam direction associated with an observed direction value associated with a blockage.

27. A non-transitory computer-readable medium storing a set of instructions for wireless communication, the set of instructions comprising:
one or more instructions that, when executed by one or more processors of a user equipment (UE), cause the UE to:
obtain measurement information regarding a set of reference signals;
generate, using a model, predicted blockage information based at least in part on the measurement information; and
transmit a report indicating the predicted blockage information, wherein the report indicates at least one of:
a prediction window associated with the predicted blockage information,
a time associated with an occurrence of a predicted blockage event,
a severity value associated with the predicted blockage event, or
a direction value associated with the predicted blockage event.

28. The non-transitory computer-readable medium of claim 27, wherein the predicted blockage information indicates the time based at least in part on at least one of a time value or a time range.

29. An apparatus for wireless communication, comprising:
means for obtaining measurement information regarding a set of reference signals;
means for generating, using a model, predicted blockage information based at least in part on the measurement information; and
means for transmitting a report indicating the predicted blockage information, wherein the report indicates at least one of:
a prediction window associated with the predicted blockage information,
a time associated with an occurrence of a predicted blockage event,
a severity value associated with the predicted blockage event, or
a direction value associated with the predicted blockage event.

30. The apparatus of claim 29, wherein the predicted blockage information indicates the time based at least in part on at least one of a time value or a time range.
